(19) United States
(12) Patent Application Publication
(10) Pub. No.: US 2008/0080838 A1
(43) Pub. Date: Apr. 3, 2008

(54) RECORDING AND REPRODUCING APPARATUS

(76) Inventors: MARI YOSHIDA, Chigasaki (JP); Nozomu Shimoda, Ninomiya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/861,387

(22) Filed: Sep. 26, 2007

(30) Foreign Application Priority Data
Sep. 29, 2006 (JP) 2006-266346

(51) Int. Cl. H04N 5/91

(52) U.S. Cl. 386/95; 386/E05.001

(57) ABSTRACT

There is little information to display on an LCD during the replicating process of image information from a first recording medium to a second recording medium. Therefore unnecessary power is consumed by keeping the luminance of the LCD high during the replicating process of the image information. In order to solve the problem, the function to restrain power consumption by changing the luminance of the backlight during the replicating process of the image information from the first recording medium to the second recording medium is provided. With the use of the above-mentioned function, the power consumption of the recording and reproducing apparatus during the replicating process of the image information from the first recording medium to the second recording medium can be restrained.

### CLAIM OF PRIORITY

The present application claims priority from Japanese application serial No. JP 2006-266346, filed on Sep. 29, 2006, the content of which is hereby incorporated by reference into this application.

### BACKGROUND OF THE INVENTION

1. Field of the Invention

The present invention relates to recording and reproducing apparatuses and more particularly to an energy saving function of a recording and reproducing apparatus used for making replicated copies of image information.

2. Description of the Related Art

A typical video camera is equipped with a liquid crystal display (LCD for short hereafter) that displays photographed images in real time. In addition, usually a backlight is installed in the LCD. The power consumption of a backlight accounts for considerable percentage of the total power consumption of a video camera with a LCD.

One of the related arts concerning the field of the present invention is Japanese Unexamined Patent Application Publication (JP-A) No. 2005-130034. JP-A-2005-130034 discloses a digital camera that reduces the luminance of the backlight of its LCD when the power saving mode is selected for photographing or reproducing, and further reduces the luminance of the backlight if the camera is not operated by a user for a certain period of time. As a result the power consumption can be restrained.

### SUMMARY OF THE INVENTION

In recent years, a hybrid video camera with two recording media mounted on it is becoming used. With the use of the hybrid video camera, it takes considerable time to replicate image information from the first recording medium to the second recording medium. In addition, there is little information to display on the LCD during the replicating process. Therefore unnecessary power is consumed by keeping the luminance of the camera high during the replicating process of the image information.

JP-A-2005-130034 discloses a power saving function to control the luminance of an LCD during photographing, but it does not disclose a technology to reduce the power consumption of the hybrid video camera when image information is replicated from the first recording medium to the second recording medium.

To solve the above-mentioned problem, the present invention provides a technology to realize the power saving of a recording and reproducing apparatus, for example, by reducing the luminance of the LCD when image information is replicated from the first recording medium to the second recording medium.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a configuration example of the recording and reproducing apparatus;

FIG. 2 is a diagram showing a flow example of the dubbing preparation;

FIG. 3 is a diagram showing a flow example of the dubbing process;

FIG. 4 is a diagram showing an example of a setting value of the luminance of the LCD;

FIG. 5 is a diagram showing a flow example of the dubbing process in a power saving mode;

FIG. 6 is a diagram showing a flow example of the dubbing process with the use of the method 1;

FIG. 7 is a diagram showing a flow example of the dubbing process with the use of the method 2;

FIG. 8 is a diagram showing a flow example of the dubbing process with the use of the method 3;

FIG. 9 is a diagram showing a flow example of the dubbing process with the use of the method 4; and

FIG. 10 is a diagram showing a flow example of the dubbing process with a judgment function of the predicted dubbing time added thereto.

### DETAILED DESCRIPTION OF THE PREFERRED EMBODIMENTS

With a hybrid video camera that includes a hard disk (a HDD for short hereafter) and a DVD (Digital Versatile Disc) taken as an example, one of the embodiments of the present invention will be described in detail with reference to the drawings. Although the present invention is particularly suitable to be applied to mobile devices driven by batteries such as a video camera, the application of the present invention is not limited to this embodiment of the present invention described hereafter.

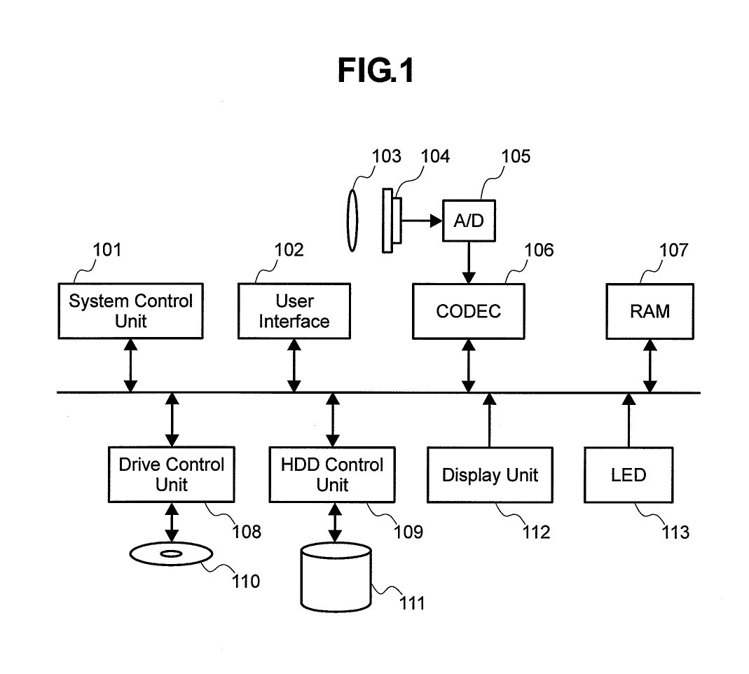

FIG. 1 is a block diagram to put this embodiment of the present invention into practice. A hybrid video camera, that is, a DVD video camera with an HDD mounted thereon will be described as an example. Instead of the HDD, a semiconductor memory or a disk medium can be used. Although there are a lot of kinds of DVDs—such as a DVD-R, a DVD-RW, a DVD-RAM, a DVD+R, and a DVD+RW, any type of DVD can be used. Of course, a BD (Blu-ray Disc) or a HD (High Definition)-DVD can be used. Other recording media such as a CD (Compact Disc) and an MD (Mini Disc) are also applicable. It will be assumed that a DVD-RAM is used in this embodiment.

A system control unit 101, which includes a CPU (Central Processing Unit) and a memory, controls the whole system. Input information from a user is obtained through a user interface 102, and it is processed by the system control unit 101. A CCD 104 converts lights taken in through a lens 103 into electric signals. An A/D converter 105 converts the analog electric signals obtained from the CCD 104 into digital electric signals, and sends the digital electric signals to a CODEC (Coder/Decoder) 106. AV streams generated after being coded by the CODEC 106 are stored in a RAM (Random Access Memory) 107. A drive control unit 108 and an HDD control unit 109 are used to control access to a DVD 110 and an HDD 111 respectively. The stream information stored in the RAM 107 is recorded on the DVD 110 and HDD 111 via the drive control unit 108 and the HDD control unit 109. Although the display unit 112 will be described hereafter as a liquid crystal display (LCD), an organic EL display, etc. can be also used as the display unit 112. An LED 113 shows the operational states of the recording and reproducing apparatus by lighting when the apparatus is being powered, or charged, or when the recording media of the apparatus are being accessed. In addition, although they are not shown, it will be assumed that all the parts to fulfill fundamental functions of a video camera, such as a battery, are mounted.

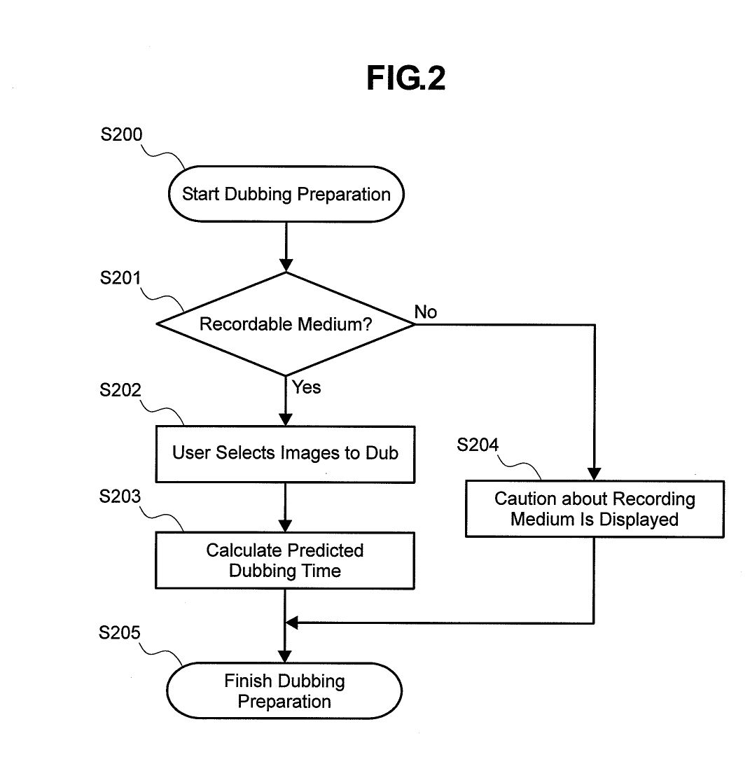

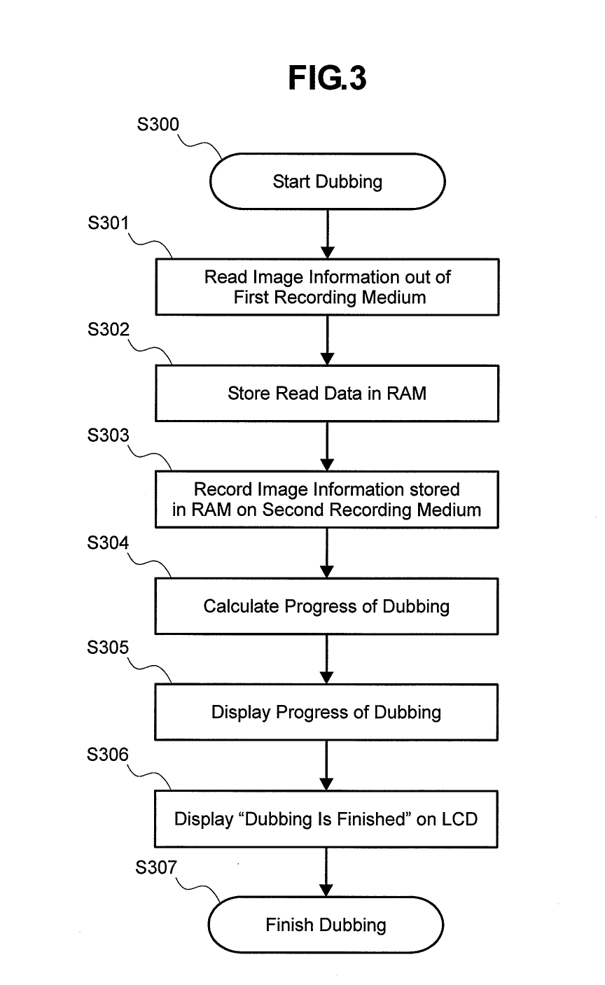

The operation of the dubbing process of the hybrid video camera related to this embodiment will be described with reference to FIG. 2 and FIG. 3.

FIG. 2 is a flowchart showing the flow of the dubbing preparation performed after a dubbing start command is delivered via the user interface 102. In this embodiment, it will be assumed that data is dubbed from the HDD to the DVD. In addition, in this embodiment, it will be assumed that the dubbing start command is issued by a user's pushing a dubbing button. After the dubbing start command is delivered at Step S200, it is judged whether the DVD is recordable or not at Step S201. For example, it is examined whether the DVD is suitable to be used for the video camera of this embodiment or not, or whether the DVD, being free from damages or defects, can correctly read or write information. If the DVD is not loaded, or not recordable, the operation of the dubbing preparation is stopped after the caution about the recording medium is displayed at Step S204. If the DVD is recordable, the user can select image information to be dubbed at Step S202. When the image information to be dubbed is selected, the time needed to dub the whole selected image information is calculated at Step S203. The predicted dubbing time can be calculated as follows. For example, if a dubbing rate is 9 Mbps (megabits per second), it takes 80 seconds to dub the image information of 90 MB (megabytes) (90 [MB]×8÷9 [Mbps]=80 [seconds]). It will be assumed that the dubbing rate is 9 Mbps in this embodiment. The capacity of a DVD 8 cm in diameter is about 1.4 GB, so it takes about 20 minutes to dub the image information of this capacity. Therefore reducing the luminance of the LCD has a large effect on the power saving. If a BD is used instead of the DVD, reducing the luminance of the LCD has a larger effect on the power saving because the capacity of the BD is larger than that of the DVD.

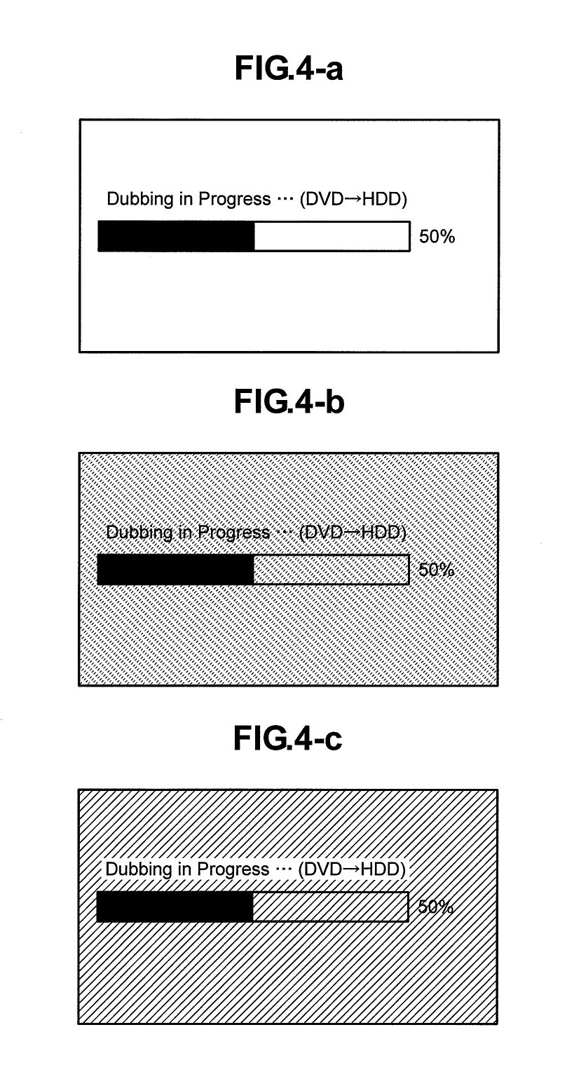

FIG. 3 shows a flowchart of the basic dubbing process. At Step 301, the image information recorded on the first recording medium HDD 111 is read out. Next, at Step 302, the image information read out is temporarily stored in the RAM 107. And then the image information stored in the RAM 107 is recorded on the second recording medium DVD 110 at Step 303. At Step 304, the progress of the dubbing process is calculated, and at Step 305, the progress of the dubbing process calculated at Step 304 is displayed on the display unit 112. To show the progress of the dubbing process, the percentage of the amount of the image information having been already dubbed relative to the total amount of the image information to be dubbed is used. For example, if the image information of 0.5 GB (Gigabytes) out of the total amount of the image information of 1.0 GB to be dubbed has been already dubbed, the percentage is 50%. Using both progress bars and figures as shown in FIG. 4 to display the progress are helpful for the user to understand the progress of the dubbing process The steps from Step 301 to Step 306 are repeated until dubbing of the total amount of the image information selected by the user is finished. Here, it will be assumed that all the steps from Step 301 to Step 306 are configured to be performed in parallel.

Generally speaking, it takes a considerable time to perform the dubbing process of image information with the use of the above-mentioned steps. For example, it takes about 20 minutes to dub the image information of 1.4 GB, which is the full capacity of a DVD 8 cm in diameter, because the dubbing rate is 9 Mbps. During this time, the information to be displayed on the LCD is only the progress of the dubbing process, and so operating the LCD at the maximum luminance leads to the unnecessary power consumption. If the video camera of this embodiment is driven by a battery, it leads to the decrease of the remaining amount of the battery capacity. Therefore, in this embodiment, plural setting values for the luminance of the LCD are prepared, so that the luminance of the LCD can be changed corresponding to any of the setting values in order to restrain the power consumption.

There are several methods to reduce the luminance of LCDs depending on types of LCD panels. For example, in the case of a normally black type of an LCD panel, the luminance of the screen can be reduced by reducing the applied voltage to the liquid crystal layer. As another method, it is also possible to reduce the luminance of the screen by reducing the supply power to an auxiliary light source such as a backlight. Particularly reducing the supply power to auxiliary light sources can effectively restrain the power consumption of LCDs. It will be assumed that the video camera of this embodiment has the function to freely change the luminance of the LCD by reducing the supply power to the auxiliary light source of the LCD.

An example of the setting of the luminance of the LCD will be described with reference to FIG. 4.

FIG. 4-a shows an example of the brightest screen with high contrast. In this instance, the luminance of the LCD has not been changed yet. The luminance of the LCD in FIG. 4-a will be termed the luminance a hereafter.

The luminance in FIG. 4-b is, for example, about 75% of the luminance a. It is as bright as letters on the screen can be easily read, and this luminance will be termed the luminance b hereafter.

The luminance in FIG. 4-c is, for example, about 30% of the luminance a. It is as bright as it can be barely judged that the LCD weakly lights, and this luminance will be termed the luminance c hereafter.

These three types of luminance are stored on the RAM 107 as the luminance setting values. The video camera of this embodiment can be configured so that the luminance of the LCD 113 is changed according to the luminance setting value that was read out beforehand. In addition, it will be also assumed that the luminance level is proportional to the amount of power consumption, so that if the power consumption of the luminance a is 100%, the power consumption of the luminance b is 75%.

The luminance zero (that is, the LCD being off) can be added to the luminance setting values. However, in this case, messages can not be displayed during dubbing operations and it is difficult for a user to understand that the dubbing operation is being performed (or that the power is not off), so that the luminance b or the luminance c is more useful than the luminance zero.

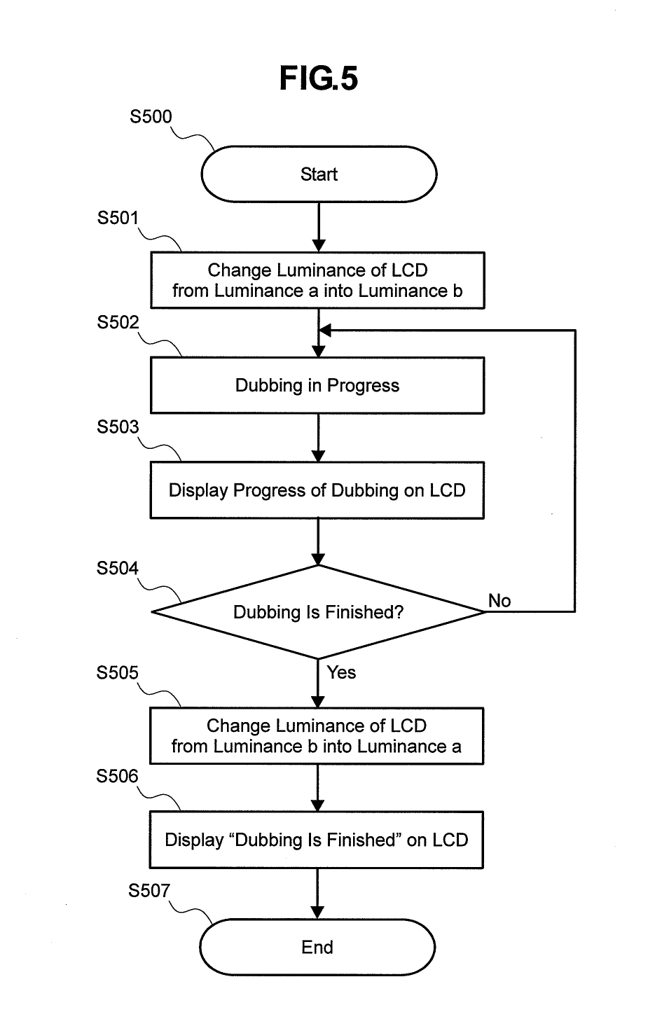

FIG. 5 is a flowchart showing the dubbing process where image information is dubbed from the first recording medium to the second recording medium of the video camera of this embodiment. It will be assumed that the luminance of the LCD is the luminance a at Step S500. If the dubbing command is delivered via the user interface 102, the luminance of the LCD is changed from the luminance a into luminance b at Step S501. In this case, the information about the luminance a before the change and the information about the luminance b after the change are stored in the RAM 107. Next, the dubbing process is performed at Step S502. The dubbing process at Step S502 consists of steps from Step S301 to Step S304 in FIG. 3. The progress of the dubbing process is displayed at Step S503 as shown in FIG. 4-b. The judgment whether the dubbing is finished or not is made at Step S504, and if the dubbing is not finished, the flow returns to Step S502, and steps from Step S502 to Step S504 are repeated until the dubbing is finished. When the dubbing is fished, the setting values are read out from the RAM 107, and the luminance of the LCD is changed from the luminance b into luminance a at Step S505. Finally at Step S506, if messages such as “Dubbing Is Finished” are displayed on the LCD to inform a user of the end of the dubbing process, it is convenient for the user to understand the end of the dubbing process. After the end of the dubbing process, either maintaining the luminance of the LCD at the luminance b or setting the luminance of the LCD zero by turning the power off is all right.

Next, as to the video camera of this embodiment, the setting change methods of the luminance of the LCD during the dubbing process will be described below.

The first method is the flow of FIG. 5 with the judgment step whether a power saving mode is selected or not added thereto. This method will be termed the method 1 hereafter. The second method is a method where the luminance of the LCD is made low when the dubbing process is started with the progress of the dubbing process displayed on the LCD, and if some action is taken by a user such as a button being pushed, the luminance of the LCD is made higher for a certain period of time. This method will be termed the method 2 hereafter. The third method is a method where the progress of the dubbing process is displayed by the blinking rhythm of the LED 113 with the backlight of the LCD completely off. This method will be termed the method 3 hereafter. The fourth method is a method where the progress of the dubbing process is displayed by the lighting colors of the LED 113 with the backlight of the LCD completely off. This method will be termed the method 4 hereafter.

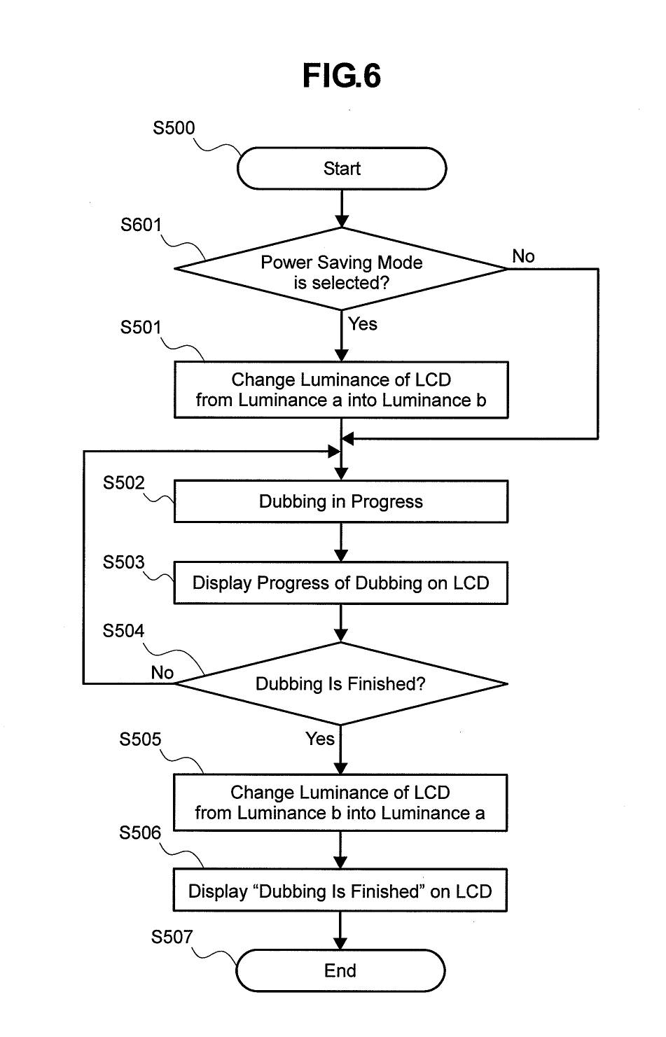

FIG. 6 is a flowchart showing the method 1. At Step 500, it will be assumed that the luminance of the LCD is the luminance a. It will be also assumed that the flag to show whether the power saving mode that reduces the luminance during the dubbing process is selected or not is stored in the RAM 107. Further, it will be assumed that the power saving mode can be set by a user with the use of a menu, etc. In addition, the factory setting for the power saving mode can be, for example, off.

If the dubbing command is delivered via the user interface 102, the judgment whether the power saving mode is selected or not is made at Step S601. The flag stored in the RAM 107 is used for the judgment. If the power saving mode is not selected, the flow proceeds to the Step S502 and the dubbing process is performed without changing the luminance of the LCD. If the power saving mode is selected, the luminance of the LCD is changed from the luminance a into the luminance b at Step S501, and the dubbing process is performed. The contents of steps from Step S502 to Step S504 are as described previously.

If the user selects the power saving mode, it is possible to effectively restrain the power consumption by reducing the luminance of the LCD during the dubbing process with the use of the above mentioned process of the method 1.

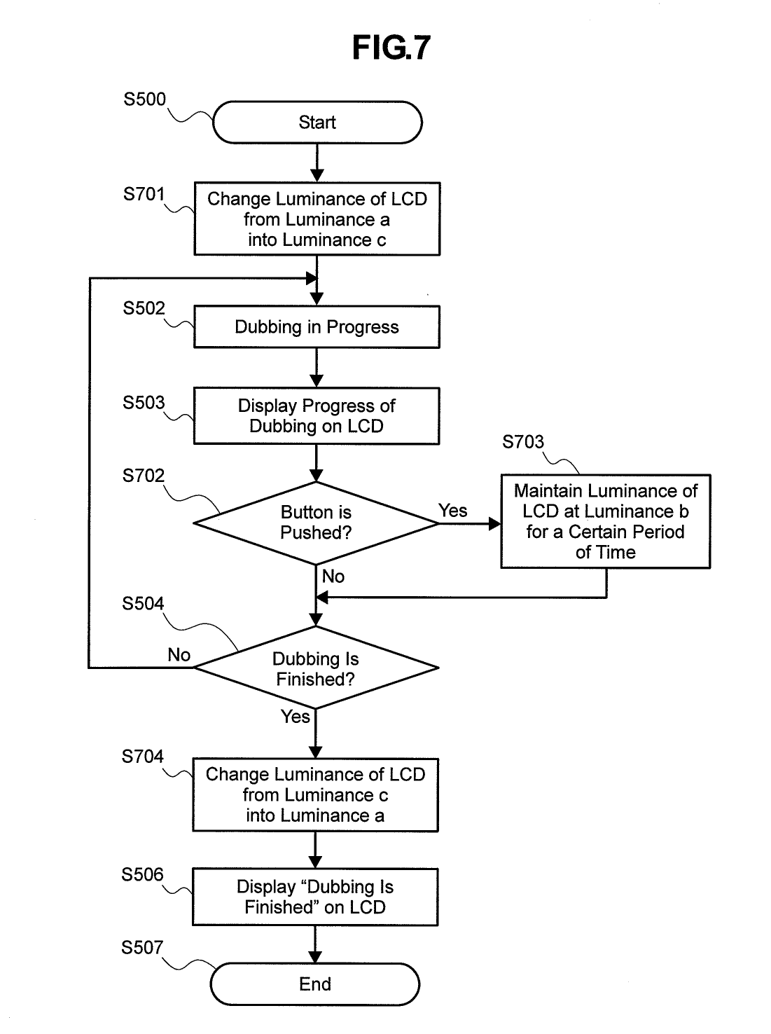

FIG. 7 shows the flowchart of the method 2. If the dubbing command is delivered via the user interface 102, the luminance of the LCD is changed from the luminance a into the luminance c at Step S701, and the dubbing process is performed through Step 502 to Step 504. During the dubbing process, it is judged whether a user performs input operations such as pushing a button or not at Step 702. If there is an input from the user, the luminance of the LCD is changed into the luminance b at Step S703 and kept being intact for a certain period of time. The certain period of time can be, for example, 10 seconds. The certain period of time can be determined in advance. If the user can change the certain period by selecting it from a menu, it will be more convenient for the user. When the certain period of time passes, the luminance of the LCD is changed from the luminance b into the luminance c. After the dubbing process is finished, the luminance of LCD is changed from the luminance c into the luminance a at Step 704. The contents of the other steps are as described previously. In Step S701 or Step S704, the luminance b can be used instead of the luminance c. Of course, the backlight of the LCD can be turned off at Step S701. In addition, the luminance a can be used instead of the luminance b.

With the use of the above mentioned process, the method 2 can restrain the power consumption more effectively than the method 1. When the user wants to know the progress of the dubbing process, some action is taken by the user such as a button being pushed. Therefore, it is convenient for the user that the luminance of the LCD is made higher responding to such an action because the user can easily grasp the progress of the dubbing process.

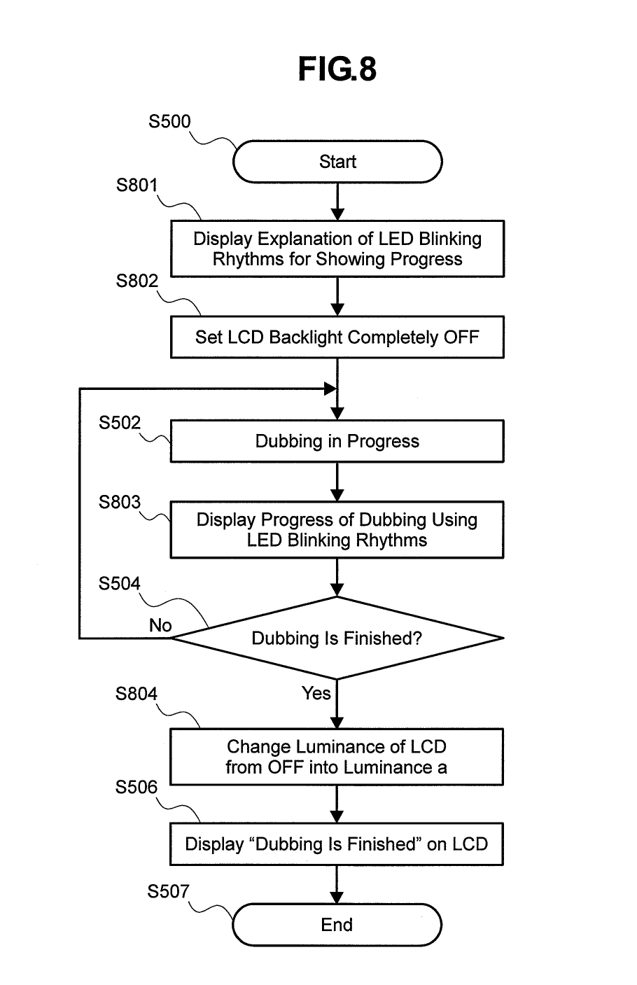

FIG. 8 shows the flowchart of the method 3. After the dubbing start command is delivered via the user interface 102, the explanation about what are meant by blinking rhythms of the LED 113 is displayed on the LCD with the luminance a at Step S801. For example, if a user is informed of the progress of the dubbing process by 25%, the control program of four types of rhythms is stored in the RAM 107 in advance and the explanation about the blinking rhythms corresponding the four states of the progress of the dubbing process—the percentages of the progress between 0% and 24%; between 25% and 49%; between 50% and 74%; and between 75% and 99%—is displayed on the LCD. The explanation about the blinking rhythms is deleted, for example, after a certain period of time passes or some action is taken by the user. Next, the backlight of the LCD is turned completely off at Step S802. At Step S803, the progress of the dubbing process is displayed by the blinking rhythm of the LED113. Of course, the blinking rhythm varies depending on the progress of the dubbing process. After the dubbing process is finished, the luminance of the LCD is changed into the luminance a at Step S804. The contents of the other steps are as described previously. As an alternative, the luminance of the LCD can be changed into the luminance b or c instead of the backlight of the LCD turned completely off at Step S802. In addition, the period of time for the explanation about the blinking rhythms of the LED to be displayed at Step S801 can be, for example, ten seconds. Otherwise the period of time for the explanation can be determined in advance, or if the user can change this period of time by selecting it from a menu, it will be convenient for the user. And further, if the user can set whether the explanation is displayed or not, it will be more convenient for the user.

With the use of the above mentioned process of the method 3, the power consumption can be drastically restrained by turning the backlight of the LCD completely off. In addition, the user can grasp the progress of the dubbing process through the blinking rhythm of the LED even if the backlight of the LCD is completely off.

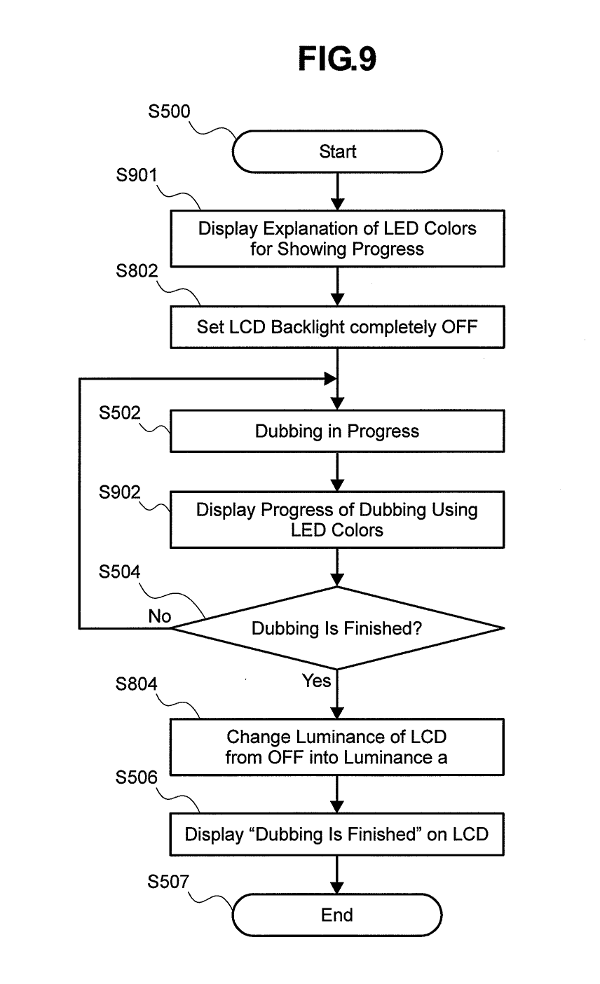

FIG. 9 shows the flowchart of the method 4.

After the dubbing start command is delivered via the user interface 102, the explanation about what are meant by the lighting colors of the LED 113 is displayed on the LCD with the luminance a at Step S901. For example, the explanation that the LED is lighted in red if the percentages of the progress of the dubbing process is between 0% and 24%; the LED is lighted in yellow if between 25% and 49%; the LED is lighted in green if between 50% and 74%; and the LED is lighted in blue if between 75% and 99% is displayed on the LCD. The explanation about the LED colors is deleted in the same timing as Step S801. At Step S802, the backlight of the LCD is turned completely off. During the dubbing process, the progress of the dubbing process is displayed by changing the colors of the LED 113 at Step S902. The contents of the subsequent steps are as described previously.

With the use of the above mentioned process of the method 4, the power consumption can be restrained by turning the backlight of the LCD completely off. In this case, even if the backlight of the LCD is turned completely off, a user can grasp the progress of the dubbing process through the lighting colors of the LED.

In addition, the judgment step whether a power saving mode is selected or not that the method 1 has can be added to the method 2 to method 4. Further, in order to make the setting of the power saving mode more conveniently, the flow can be configured so that a user selects his favorite setting method from several setting methods of the power saving modes using a menu and the selected setting method of the power saving mode is stored in the RAM 107. Then the selected setting method is read out and used at Step S601 which is originally the judgment step of whether the power saving mode is selected or not, with the result that the video camera of this embodiment operates according to the power saving mode selected by the user.

In addition, the power saving modes are not to be considered limited to what are described above, and they can be the combination of the methods from the method 1 to method 4. For example, the combination of the method 3 and the method 4 makes it possible to display the progress of the dubbing process by both the blinking rhythms and the colors of the LED 113, so that the LED capable of emitting two colors will do for displaying the progress in stead of the LED capable of emitting four colors needed by the method 4.

When the amount of image information to be dubbed is small, the dubbing time is short. If the dubbing time is extremely short, changing the luminance of the LCD does not have a remarkable effect on the power saving. Therefore, in order to make the power saving mode more effective, it is conceivable to add the judgment whether the predicted dubbing time is longer than a certain period of time or not before changing the luminance of the LCD.

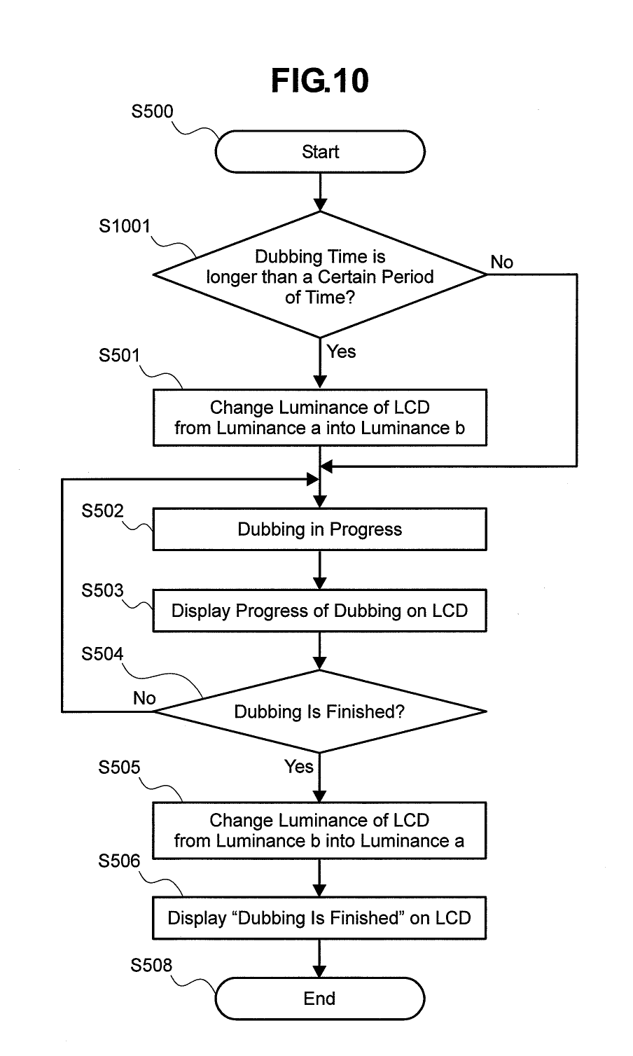

FIG. 10 shows the flowchart of FIG. 5 with the judgment of the predicted dubbing time added thereto. If the dubbing command is delivered via the user interface 102, it is judged whether the predicted dubbing time is longer than a certain period of time or not. If the predicted dubbing time is longer than the certain period of time, the dubbing process is performed with the luminance of the LCD changed. If the predicted dubbing time is shorter than the certain period of time, the dubbing process is performed without changing the luminance of the LCD. For example, the certain period of time can be five minutes. The certain period of time can be determined in advance, or if a user can change the certain period of time by selecting it from a menu, it will be more convenient for the user. Even in the case where the power saving mode is not selected by the user, it is conceivable to restrain the power consumption by making the luminance of the LCD lower if the predicted dubbing time is longer than the certain period of time. Step S1001 can be applied to all the methods from the method 1 to the method 4.

In this embodiment, the dubbing process is performed with the use of a battery or commercial power supply, and the effect of this embodiment can be obtained regardless of the power supply means. As an alternative, this embodiment can be configured so that the luminance of the LCD is not changed when the commercial power supply is used, and the luminance of the LCD is reduced when the battery is used.

According to the above described methods, it is possible to restrain the power consumption of a recording and reproducing apparatus, for example, during the replicating process of image information from the first medium to the second medium.

While we have shown and described several embodiments in accordance with our invention, it should be understood that disclosed embodiments are susceptible to changes and modifications without departing from the scope of the invention. Therefore, we do not intend to bound by the details shown and described herein but intend to cover all such changes and modifications as fall within the ambit of the appended claims.

What is claimed is:

1. A recording and reproducing apparatus equipped with a plurality of recording media, comprising:
an image information input module which has an image pickup element;
a recording module which records the image information sent from the image information input module on a recording medium;
a reproducing module which reproduces the image information recorded on the recording medium;
a replicating module which performs a replicating process to replicate or transfer image information from a first recording medium to a second recording medium;
a display module which displays images; and
a control module which reduces the luminance of the display module during the replicating process of the image information from the first recording medium to the second recording medium.

2. The recording and reproducing apparatus according to claim 1, wherein
a user can set the luminance of the display module during the replicating process of the image information from the first recording medium to the second recording medium.

3. The recording and reproducing apparatus according to claim 1, wherein
the control module displays the information about the progress of the replicating process on the display module during the replicating process of the image information from the first recording medium to the second recording medium.

4. The recording and reproducing apparatus according to claim 1, further comprising
a light emitting element which shows the operational states of the recording and reproducing apparatus, wherein
the control module displays the progress of the replicating process by the blinking rhythms or the luminescent colors of the light emitting element during the replicating process of the image information from the first recording medium to the second recording medium.

5. The recording and reproducing apparatus according to claim 1, wherein
the luminance of the display module, which has been made low during the replicating process of the image information from the first recording medium to the second recording medium, is made high after the replicating process is over.

6. The recording and reproducing apparatus according to claim 1, further comprising
a prediction module which calculates a predicted time needed by the replicating process of the image information from the first recording medium to the second recording medium, wherein
the control module makes the luminance of the display module low during the replicating process if the predicted time calculated by the prediction module is longer than a certain period of time.
